(19) United States
(12) Patent Application Publication
(10) Pub. No.: US 2006/0203206 A1
(43) Pub. Date: Sep. 14, 2006

(54) Cooling apparatus and a projector having the same

(75) Inventor: Won-nyun Kim, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/327,486

(22) Filed: Jan. 9, 2006

(30) Foreign Application Priority Data
Mar. 8, 2005 (KR) 2005-18916

(51) Int. Cl. G03B 21/18; G03B 21/26

(52) U.S. Cl. 353/58

(57) ABSTRACT

A projector includes a first LED module having a first LED projecting a ray of one of three primary colors of light and a first substrate mounting the first LED. A second LED module includes second and third LEDs projecting the other two colors of the three primary colors and a second substrate mounting the second and third LEDs. An optical illuminating system uniformly focuses and projects red, green and blue rays emitted from the first to third LEDs. A display unit forms an image by modulating the light projected from the optical illuminating system according to image information. An optical projecting system enlargingly projects the image formed by the display unit onto a screen. A cooling apparatus cools and therefore keeps the first to third LEDs at approximately the same temperature.

### CROSS-REFERENCE TO RELATED APPLICATIONS

This application claims the benefit under 35 U.S.C. § 119(a) of Korean Patent Application No. 2005-18916, filed Mar. 8, 2005, the entire contents of which are hereby incorporated by reference.

### BACKGROUND OF THE INVENTION

1. Field of the Invention

The present invention relates to a projector. More particularly, the present invention relates to a projector using a light emitting diode (LED) as a light source, and a cooling apparatus for the projector.

2. Description of the Related Art

In a projector using a light emitting diode (LED) as a light source, some component parts, such as a color wheel filter, can be omitted unlike in general projectors. Therefore, the projector using the LED can be made in a more portable size. Furthermore, since the projector using the LED can obtain rays of three primary colors of superior quality, the projector can be more slight, simply-structured and inexpensive.

However, such projectors using LEDs are difficult to provide with an inner space sufficient for heat release. The LED, in which the quantity and brightness of the light deteriorate over a certain temperature, needs to be kept under a certain temperature. A color shift may be generated when the temperatures of the LEDs respectively projecting red, green and blue rays are different from one another, such that a plurality of the LEDs are required to be kept at the same temperature.

When a plurality of the LEDs do not have the same temperature, a white balance may occur due to variation of the quantity and brightness of the light between the LEDs, thereby degrading image quality. As a result, a cooling apparatus is required to keep the respective LEDs at approximately the same temperature by cooling.

Accordingly, a need exists for an image projector having LEDs in which a cooling apparatus maintains the LEDs at approximately the same temperature, thereby maintaining image quality.

### SUMMARY OF THE INVENTION

Accordingly, an aspect of the present invention is to provide a cooling apparatus for a compact-sized projector using a light emitting diode (LED) capable of cooling a plurality of LEDs to keep the LEDs at approximately the same temperature.

Another aspect of the present invention is to provide a projector capable of maintaining superior image quality by having the cooling apparatus.

A cooling apparatus for a projector having at least two light emitting diode (LED) modules projecting red, green and blue rays includes a first cooling member mounting a first LED module, and a second cooling member mounting a second LED module. A heat pipe thermally connects the first and the second cooling members. A cooling fin member is mounted at one of the first and the second cooling members. A fan cools the cooling fin member by propelling air toward the cooling fin member.

The first and the second cooling members are preferably disposed substantially perpendicularly to each other. The fan is preferably mounted to one of the cooling members, which has the cooling fin member propelling air toward the cooling fin member.

The second cooling member includes the cooling fin member and the fan. However, the present invention is not limited to such an exemplary embodiment. According to the structure of a projector casing and arrangement of optical parts, the cooling fin member and the fan may be mounted to the first cooling member.

The first and the second cooling members are preferably formed of aluminum.

Another aspect of the present invention may be achieved by providing a projector including a light source, a display unit modulating light projected from the light source according to image information to thereby form an image, and an optical projecting system enlargingly projecting the image formed by the display unit. The projector further includes a plurality of LEDs serving as the light source and respectively projecting red, green and blue rays. A cooling apparatus uses a heat pipe for cooling and keeping the plurality of LEDs at approximately the same temperature.

The cooling apparatus includes a cooling member divided into first and second cooling members thermally connected by the heat pipe. The first cooling member mounts a first LED among the plurality of LEDs that projects a ray of a certain color. The second cooling member mounts second and third LEDs respectively projecting rays of two other colors. A cooling fin member includes a plurality of cooling fins mounted to one of the first and the second cooling members. A fan cools the cooling fin member by propelling air toward the cooling fin member.

The cooling fin member and the fan are preferably mounted to the second cooling member.

According to an exemplary embodiment of the present invention, a projector includes a first LED module having a first LED projecting a ray of one of three primary colors of light and a first substrate mounting the first LED. A second LED module includes second and third LEDs projecting the other two colors of the three primary colors and a second substrate mounting the second and third LEDs. An optical illuminating system focuses and uniformly projects red, green and blue rays emitted from the first to the third LEDs. A display unit forms an image by modulating the light projected from the optical illuminating system according to image information. An optical projecting system enlargingly projects the image formed by the display unit onto a screen. A cooling apparatus cools and therefore keeps the first to third LEDs at approximately the same temperature.

The cooling apparatus includes a first cooling member mounting a first LED module, and a second cooling member mounting a second LED module. A heat pipe thermally connects the first and second cooling members. A cooling fin member is mounted at one of the first and second cooling members. A fan cools the cooling fin member by propelling air toward the cooling fin member.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIGS. 1 and 2 are perspective views of a cooling apparatus according to an exemplary embodiment of the present invention from different angles, respectively;

FIG. 3 is an exploded, perspective view of the cooling apparatus according to an exemplary embodiment of the present invention;

FIG. 4 is a perspective view schematically showing a projector having a cooling apparatus according to an exemplary embodiment of the present invention; and

FIG. 5 is a diagrammatic illustration of an optical path of the projector of FIG. 4.

Throughout the drawings, like reference numerals will be understood to refer to like parts, components and structures.

### DETAILED DESCRIPTION OF EXEMPLARY EMBODIMENTS

Hereinafter, certain exemplary embodiments of the present invention are described in detail with reference to the accompanying drawing figures.

The matters defined in the description, such as a detailed construction and elements thereof, are provided to assist in a comprehensive understanding of the present invention. Thus, it is apparent that the present invention may be carried out without those defined matters. Also, well-known functions or constructions are omitted to facilitate providing a clear and concise specification.

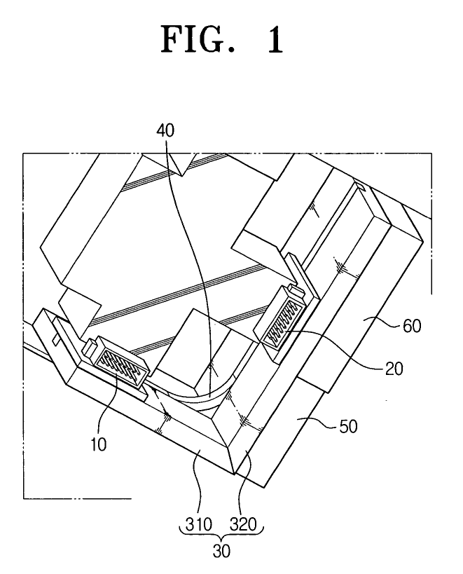

Referring to FIGS. 1 through 3, a cooling apparatus for a projector includes a cooling member 30 having first and second light emitting diode (LED) modules 10 and 20, a heat pipe 40, a cooling fin member 50 and a fan 60.

The cooling member 30 includes a first cooling member 310 mounting the first LED module 10 and a second cooling member 320 mounting the second LED module 20. The cooling member 30 is preferably formed of metal having superior thermal conductivity, such as aluminum. Therefore, heat generated at the respective LED modules 10 and 20 is transmitted to the cooling member 30. Although the present exemplary embodiment adopts aluminum for the cooling member 30, this is only an exemplary application. Therefore, any other suitable substance having high thermal conductivity may be used. Also, although the first and the second cooling members 310 and 320 are arranged substantially perpendicularly to each other in the drawings, the present invention is not so limited. The arrangement of the first and the second cooling members 310 and 320 may be varied according to the structure of an outer casing of the projector and the arrangement of other optical parts.

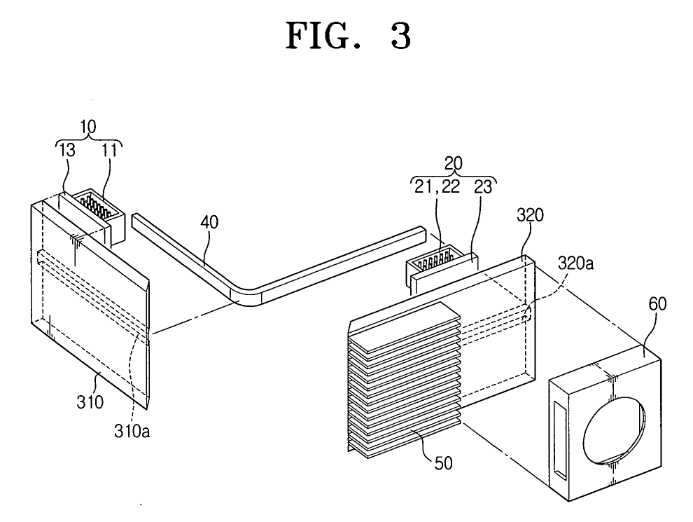

The heat pipe 40 is mounted in the first and the second cooling members 310 and 320 to thermally connect the first and the second cooling members 310 and 320. To facilitate mounting of the heat pipe 40, heat pipe mounting grooves 310a and 320a are provided respectively in the first and second cooling members 310 and 320, as shown in FIG. 3. Being thermally connected by the heat pipe 40, the first and second cooling members 310 and 320 may be maintained at approximately the same temperature as each other and accordingly, the first and second LED modules 10 and 20 attached respectively to the cooling members 310 and 320 may be controlled at approximately the same temperature.

The cooling fin member 50 is mounted to one of the first and the second cooling members 310 and 320. In this exemplary embodiment, the second cooling member 320 has the cooling fin member 50 at one side thereof. The cooling fin member 50 includes a plurality of cooling fins 51 of a plate form arranged at certain intervals. The cooling fin member 50 may be integrally formed with the second cooling member 320 or separately formed and attached to the second cooling member 320. Also, the cooling fin member 50 is preferably formed of aluminum having superior thermal conductivity, which is preferably the same substance as the cooling members 310 and 320. It is apparent that the cooling fin member 50 may be mounted to the first cooling member 310 instead of the second cooling member 320.

The fan 60 ventilates the cooling fin member 50 with relatively cold external air to cool the cooling fin member 50. Therefore, the fan 60 is preferably disposed adjacent to the second cooling member 320 having the cooling fin member 50.

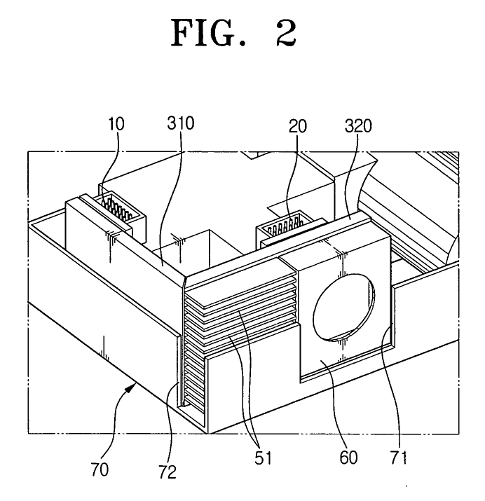

In FIG. 2, reference numeral 70 denotes an outer casing of the projector. The outer casing 70 includes an air inlet 71 and an air outlet 72.

In the above-structured cooling apparatus, the heat generated during operation of the first and the second LED modules 10 and 20 is transmitted to the first and second cooling members 310 and 320. Additionally, the heat transmitted to the cooling fin member 50 may be cooled by the operation of the fan 60, which propels external air toward the cooling fin member 50. Here, since the first and second cooling members 310 and 320 are connected by the heat pipe 40, the first and second cooling members 310 and 320 may be thermally balanced, that is, controlled to have approximately the same temperature. Accordingly, the first and second LED modules 10 and 20 may be cooled to approximately the same temperature.

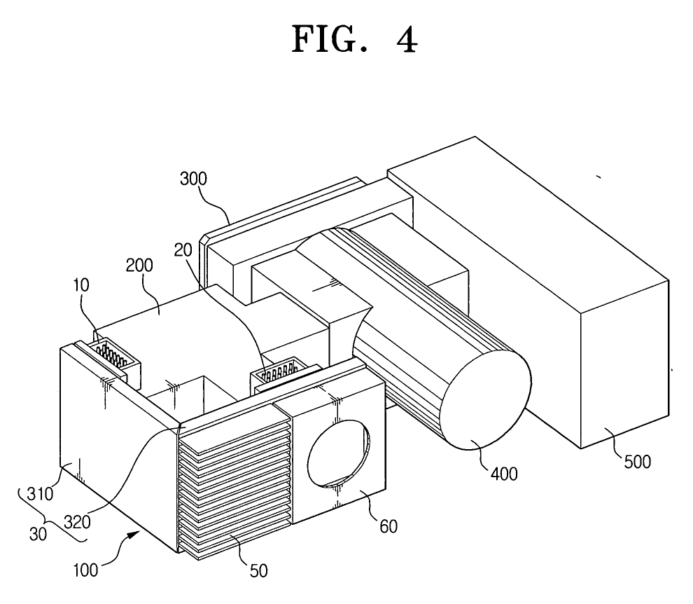

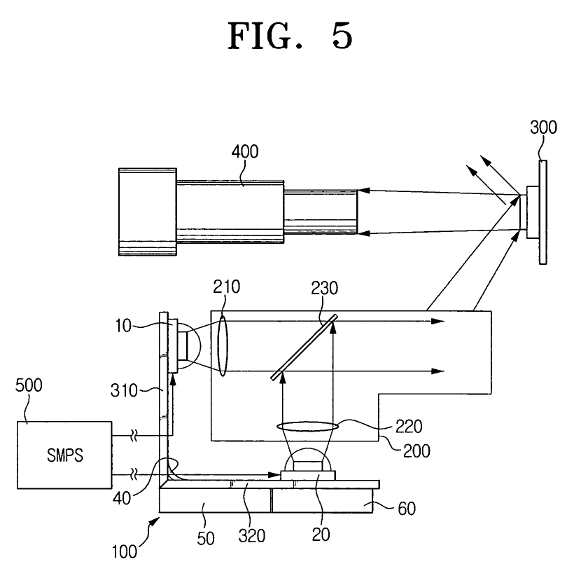

FIGS. 4 and 5 schematically illustrate a projector employing the cooling apparatus 100 as described above. The component parts constituting the cooling apparatus 100, which have already been described, will be cited by the same reference numerals and are not described in detail again.

The first and the second LED modules 10 and 20 are explained first. The first LED module 10 includes a first LED 11 projecting a ray of one of the three primary colors of light, for example, green. A first substrate 13 mounts the first LED 11. The second LED module 20 includes second and third LEDs 21 and 22 projecting red and blue rays, respectively, which are the remaining two colors of the three primary colors. A second substrate 23 mounts the second and third LEDs 21 and 22.

As aforementioned, the fist and second LED modules 10 and 20 respectively project the red, green and blue rays, and are attached to the first and the second cooling members 310 and 320. Heat is generated at the LEDs 11, 21 and 22 at this time. Since the heat is controlled by the cooling apparatus as described above, the color shift caused by a temperature difference between the respective LEDs is substantially prevented.

An optical illuminating system 200 may be used for image formation in a display unit 300 by uniformly focusing the rays of the three primary colors. The optical illuminating system 200 includes first and second collimating lenses 210 and 220, a dichroic filter 230 transmitting and reflecting light, and a condenser lens (not shown).

The display unit 300 modulates the light projected from the optical illuminating system 200 based on image information, thereby forming an image. A digital micromirror device (DMD) panel or a liquid crystal display (LCD) panel may be employed for the display unit 30.

An optical projecting system 400 forms the image by enlargingly projecting the image formed in the display unit 300 onto a screen (not shown). Since the structure and the operation of the optical transmission system 400 are substantially similar to those of conventional projectors, a detailed description thereof is omitted.

Reference numeral 500 denotes a switching mode power supply (SMPS) that includes a direct current (DC) power supply for providing the respective LEDs with DC power.

In the above-structured projector, the rays of the three primary colors are uniformly focused through the optical illuminating system 200, irradiated to the display unit 300 and modulated in the display unit 300 according to the image information, thereby forming an image. A desired image is finally implemented by enlargingly projecting the image onto the screen using the optical projecting system 400. The heat generated by the respective LEDs during these processes is cooled by the cooling apparatus 100 and accordingly, the LEDs may be kept at approximately the same temperature.

As a result, deterioration of the white balance, which may be caused when the temperatures of the LEDs are different, is substantially prevented.

As may be appreciated from the above description of the cooling apparatus 100 according to an exemplary embodiment of the present invention, the heat generated by the LEDs in a compact-sized projector using the LEDs as the light source may be effectively cooled. Moreover, since the plurality of LEDs are controlled to be maintained at approximately the same temperature, the color shift or deterioration of the white balance is substantially prevented. Consequently, the image quality is enhanced.

While the invention has been shown and described with reference to certain embodiments thereof, it will be understood by those skilled in the art that various changes in form and details may be made therein without departing from the spirit and scope of the invention as defined by the appended claims.

What is claimed is:

1. A cooling apparatus for a projector having at least two light emitting diode (LED) modules projecting red, green and blue rays, comprising:
a first cooling member mounting a first LED module;
a second cooling member mounting a second LED module;
a heat pipe thermally connecting the first and second cooling members;
a cooling fin member mounted to one of the first and second cooling members; and
a fan cooling the cooling fin member by propelling air toward the cooling fin member.

2. The cooling apparatus of claim 1, wherein
the first and second cooling members are disposed substantially perpendicularly to each other.

3. The cooling apparatus of claim 2, wherein
the fan is mounted to the cooling member to which the cooling fin member is mounted.

4. The cooling apparatus of claim 3, wherein
the second cooling member includes the cooling fin member and the fan.

5. The cooling apparatus of claim 1, wherein
the first and second cooling members are formed of aluminum.

6. The cooling apparatus of claim 1, wherein
the cooling fin member is made of aluminum.

7. A projector, comprising:
a light source;
a display unit modulating light projected from the light source according to image information to form an image; and
an optical projecting system enlargingly projecting the image formed by the display unit;
a plurality of LEDs serving as the light source and respectively projecting red, green and blue rays; and
a cooling apparatus that uses a heat pipe for cooling and keeping the plurality of LEDs at approximately the same temperature.

8. The projector of claim 7, wherein the cooling apparatus includes
a cooling member divided into first and second cooling members thermally connected by the heat pipe, the first cooling member mounting a first LED projecting a ray of a certain color and the second cooling member mounting second and third LEDs respectively projecting rays of two other colors.

9. The projector of claim 8, wherein the cooling apparatus includes
a cooling fin member includes a plurality of cooling fins mounted to one of the first and the second cooling members.

10. The projector of claim 9, wherein the cooling apparatus includes
a fan cooling the cooling fin member by propelling air toward the cooling fin member.

11. The projector of claim 8, wherein
the cooling fin member and the fan are mounted to the second cooling member.

12. The projector of claim 11, wherein
the first and second cooling members are substantially perpendicular to each other.

13. The cooling apparatus of claim 8, wherein
the first and second cooling members are formed of aluminum.

14. The cooling apparatus of claim 9, wherein
the cooling fin member is made of aluminum.

15. A projector, comprising:
a first LED module having a first LED projecting a ray of one of three primary colors of light and a first substrate mounting the first LED;
a second LED module having second and third LEDs projecting the other two colors of the three primary colors and a second substrate mounting the second and third LEDs;
an optical illuminating system focusing and uniformly projecting red, green and blue rays emitted from the first to third LEDs;
a display unit forming an image by modulating the light projected from the optical illuminating system according to image information;
an optical projecting system enlargingly projecting the image formed by the display unit onto a screen; and
a cooling apparatus cooling and keeping the first to third LEDs at approximately the same temperature.

16. The projector of claim 15, wherein the cooling apparatus includes
a first cooling member mounting a first LED module;
a second cooling member mounting a second LED module;
a heat pipe thermally connecting the first and second heating members;
a cooling fin member mounted to one of the first and second cooling members; and
a fan cooling the cooling fin member by propelling air toward the cooling fin member.

17. The projector of claim 16, wherein
the first and the second cooling members are arranged substantially perpendicularly to each other.

18. The projector of claim 17, wherein
the fan is mounted to the cooling member to which the cooling fin member is mounted.

19. The projector of claim 18, wherein
the second cooling member includes the cooling fin member and the fan.

20. The projector of claim 16, wherein
the first and the second cooling members are formed of aluminum.
